(19) United States
(12) Patent Application Publication
(10) Pub. No.: US 2011/0265039 A1
(43) Pub. Date: Oct. 27, 2011

(54) CATEGORY-BASED LIST NAVIGATION ON TOUCH SENSITIVE SCREEN

(75) Inventors: Jeremy Lyon, Sunnyvale, CA (US); Daniel Marc Gatan Shiplacoff, Los Angeles, CA (US); Brandon Keely, San Francisco, CA (US); Jesse Donaldson, Mountain View, CA (US)

(73) Assignee: PALM, INC., Sunnyvale, CA (US)

(21) Appl. No.: 12/765,807

(22) Filed: Apr. 22, 2010

(51) Int. Cl. G06F 3/048; G06F 3/033

(52) U.S. Cl. 715/830; 715/863

(57) ABSTRACT

A mechanism for a user to navigate a list on a touch sensitive screen by making on-screen gestures is described. Items in the list are sorted based on a common attribute, and grouped into different categories associated with the attribute. A portion of the items are displayed in the sorted sequence in a graphical user interface (UI) on a touch sensitive screen. When the user makes an on-screen gesture, one or more corresponding categories are identified and their indicators are dynamically and prominently displayed as feedback. Once the gesture is completed, the graphical UI scrolls to the portion of the list including items in the desired category.

### BACKGROUND

1. Field of Art

The disclosure generally relates to the field of graphical user interface control in computing devices.

2. Description of Art

Content such as contacts and emails are often displayed in a list format. On some devices, it may be challenging for users to navigate a long list on a small area touch sensitive screen. Accordingly, there is lacking in the art, inter alia, techniques for enabling the user to navigate within a list displayed on a small area touch sensitive screen, for example, on a mobile computing device.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1a illustrates one embodiment of a mobile computing device in a first positional state.

FIG. 1b illustrates one embodiment of the mobile computing device in a second positional state.

FIG. 2 illustrates one embodiment of an architecture of a mobile computing device.

FIG. 3 illustrates one embodiment of an architecture of a list manager module.

FIG. 4 illustrates one embodiment of a process of a list manager module.

FIGS. 5, 6, and 7A-B are screenshots of a graphical user interface according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### GENERAL OVERVIEW

One embodiment of a disclosed system (and method and non-transitory computer readable storage medium) enables a user to navigate a list on a touch sensitive screen by making on-screen gestures. Items in the list are sorted based on a common attribute, and grouped into different categories associated with the attribute. A portion of the items are displayed in the sorted sequence in a graphical user interface (UI) on a touch sensitive screen. When the user makes an on-screen gesture, one or more corresponding categories are identified and their indicators are dynamically and prominently displayed as feedback. Based on the visual feedback, the user can make gestures in a desirable direction (e.g., upward towards the beginning of the list or downward towards the end of the list) until a desired category is reached (e.g., when the indicator of the desired category is displayed). Once the gesture is completed, the graphical UI scrolls to the portion of the list including items in the desired category.

### Example Mobile Computing Device

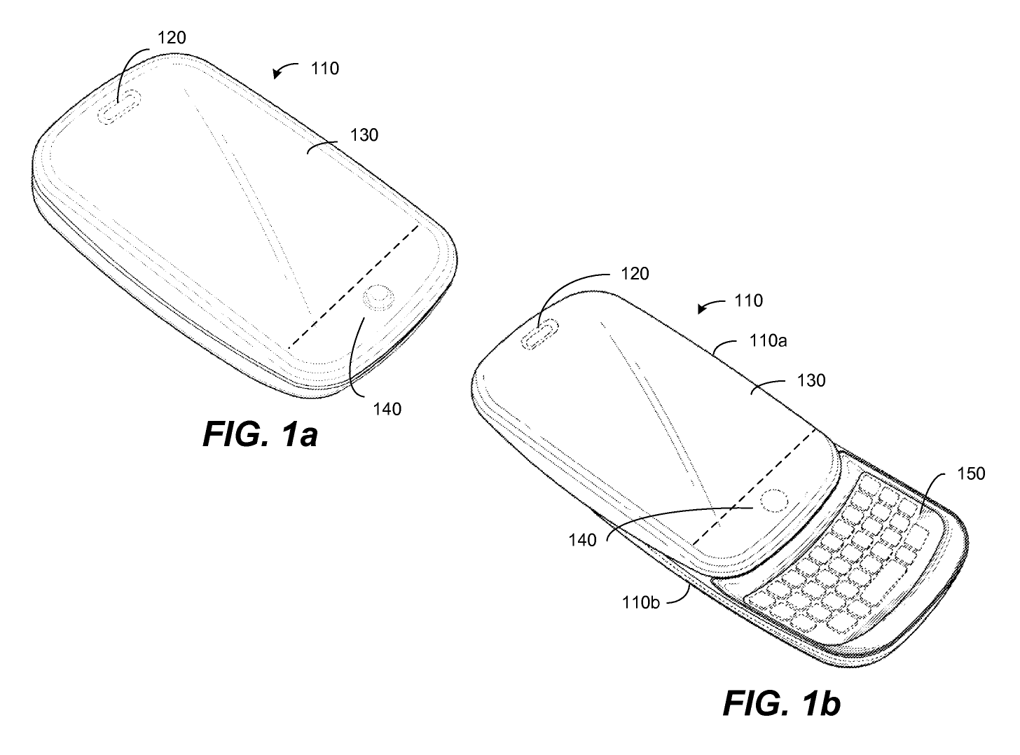

In one example embodiment, the configuration as disclosed may be configured for use between a mobile computing device, that may be host device, and an accessory device. FIGS. 1a and 1b illustrate one embodiment of a mobile computing device 110. Figure (FIG.) 1a illustrates one embodiment of a first positional state of the mobile computing device 110 having telephonic functionality, e.g., a mobile phone or smartphone. FIG. 1b illustrates one embodiment of a second positional state of the mobile computing device 110 having telephonic functionality, e.g., a mobile phone, smartphone, netbook, or laptop computer. The mobile computing device 110 is configured to host and execute a phone application for placing and receiving telephone calls.

It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) and/or data networks having voice over internet protocol (VoIP) functionality. Likewise, the mobile computing device 110 is only by way of example, and the principles of its functionality apply to other computing devices, e.g., desktop computers, server computers and the like.

The mobile computing device 110 includes a first portion 110a and a second portion 110b. The first portion 110a comprises a screen for display of information (or data) and may include navigational mechanisms. These aspects of the first portion 110a are further described below. The second portion 110b comprises a keyboard and also is further described below. The first positional state of the mobile computing device 110 may be referred to as an “open” position, in which the first portion 110a of the mobile computing device slides in a first direction exposing the second portion 110b of the mobile computing device 110 (or vice versa in terms of movement). The mobile computing device 110 remains operational in either the first positional state or the second positional state.

The mobile computing device 110 is configured to be of a form factor that is convenient to hold in a user's hand, for example, a personal digital assistant (PDA) or a smart phone form factor. For example, the mobile computing device 110 can have dimensions ranging from 7.5 to 15.5 centimeters in length, 5 to 15 centimeters in width, 0.5 to 2.5 centimeters in thickness and weigh between 50 and 250 grams.

The mobile computing device 110 includes a speaker 120, a screen 130, and an optional navigation area 140 as shown in the first positional state. The mobile computing device 110 also includes a keypad 150, which is exposed in the second positional state. The mobile computing device also includes a microphone (not shown). The mobile computing device 110 also may include one or more switches (not shown). The one or more switches may be buttons, sliders, or rocker switches and can be mechanical or solid state (e.g., touch sensitive solid state switch).

The screen 130 of the mobile computing device 110 is, for example, a 240×240, a 320×320, a 320×480, or a 640×480 touch sensitive (including gestures) display screen. The screen 130 can be structured from, for example, such as glass, plastic, thin-film or composite material. In one embodiment the screen may be 1.5 inches to 5.5 inches (or 4 centimeters to 14 centimeters) diagonally. The touch sensitive screen may be a transflective liquid crystal display (LCD) screen. In alternative embodiments, the aspect ratios and resolution may be different without departing from the principles of the inventive features disclosed within the description. By way of example, embodiments of the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitive), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The optional navigation area 140 is configured to control functions of an application executing in the mobile computing device 110 and visible through the screen 130. For example, the navigation area includes an x-way (x is a numerical integer, e.g., 5) navigation ring that provides cursor control, selection, and similar functionality. In addition, the navigation area may include selection buttons to select functions displayed through a user interface on the screen 130. In addition, the navigation area also may include dedicated function buttons for functions such as, for example, a calendar, a web browser, an e-mail client or a home screen. In this example, the navigation ring may be implemented through mechanical, solid state switches, dials, or a combination thereof. In an alternate embodiment, the navigation area 140 may be configured as a dedicated gesture area, which allows for gesture interaction and control of functions and operations shown through a user interface displayed on the screen 130.

The keypad area 150 may be a numeric keypad (e.g., a dialpad) or a numeric keypad integrated with an alpha or alphanumeric keypad or character keypad 150 (e.g., a keyboard with consecutive keys of Q-W-E-R-T-Y, A-Z-E-R-T-Y, or other equivalent set of keys on a keyboard such as a DVORAK keyboard or a double-byte character keyboard).

Although not illustrated, it is noted that the mobile computing device 110 also may include an expansion slot. The expansion slot is configured to receive and support expansion cards (or media cards). Examples of memory or media card form factors include COMPACTFLASH, SD CARD, XD CARD, MEMORY STICK, MULTIMEDIA CARD, SDIO, and the like.

### Example Mobile Computing Device Architectural Overview

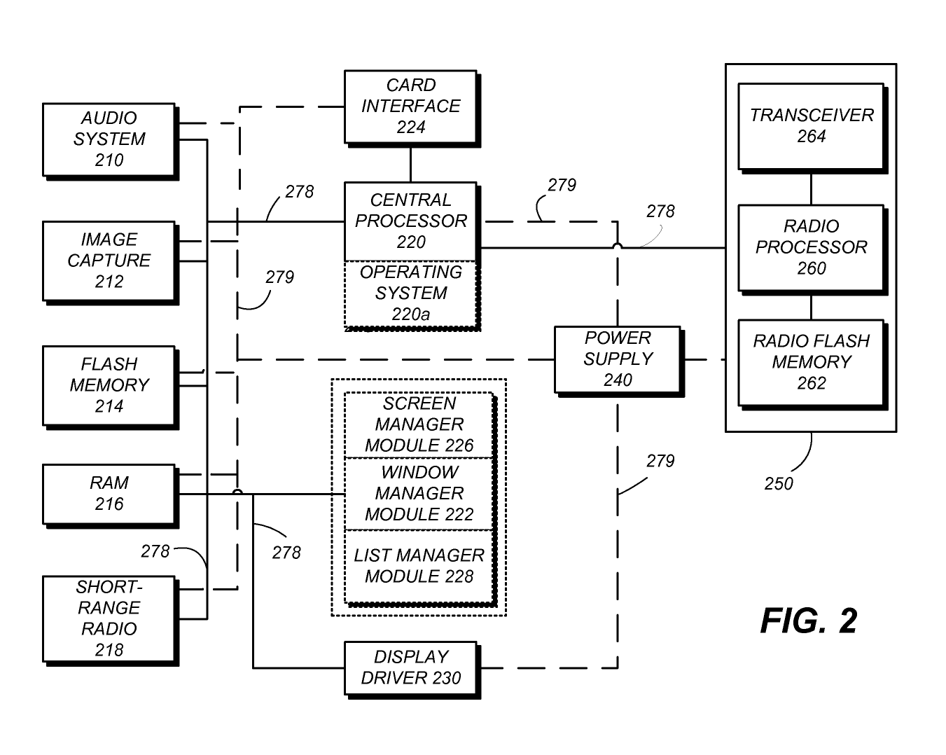

Referring next to FIG. 2, a block diagram illustrates one embodiment of an architecture of a mobile computing device 110, with telephonic functionality. By way of example, the architecture illustrated in FIG. 2 will be described with respect to the mobile computing device of FIGS. 1a and 1b. The mobile computing device 110 includes a central processor 220, a power supply 240, and a radio subsystem 250. Examples of a central processor 220 include processing chips and system based on architectures such as ARM (including cores made by microprocessor manufacturers), ARM XSCALE, AMD ATHLON, SEMPRON or PHENOM, INTEL ATOM, XSCALE, CELERON, CORE, PENTIUM or ITANIUM, IBM CELL, POWER ARCHITECTURE, SUN SPARC and the like.

The central processor 220 is configured for operation with a computer operating system 220a. The operating system 220a is an interface between hardware and an application, with which a user typically interfaces. The operating system 220a is responsible for the management and coordination of activities and the sharing of resources of the mobile computing device 110. The operating system 220a provides a host environment for applications that are run on the mobile computing device 110. As a host, one of the purposes of an operating system is to handle the details of the operation of the mobile computing device 110. Examples of an operating system include PALM OS and WEBOS, MICROSOFT WINDOWS (including WINDOWS 7, WINDOWS CE, and WINDOWS MOBILE), SYMBIAN OS, RIM BLACKBERRY OS, APPLE OS (including MAC OS and IPHONE OS), GOOGLE ANDROID, and LINUX.

The central processor 220 communicates with an audio system 210, an image capture subsystem (e.g., camera, video or scanner) 212, flash memory 214, RAM memory 216, and a short range radio module 218 (e.g., Bluetooth, Wireless Fidelity (WiFi) component (e.g., IEEE 802.11)). The central processor 220 communicatively couples these various components or modules through a data line (or bus) 278. The power supply 240 powers the central processor 220, the radio subsystem 250 and a display driver 230 (which may be contact—or inductive-sensitive). The power supply 240 may correspond to a direct current source (e.g., a battery pack, including rechargeable) or an alternating current (AC) source. The power supply 240 powers the various components through a power line (or bus) 279.

The central processor communicates with applications executing within the mobile computing device 110 through the operating system 220a. In addition, intermediary components, for example, a window manager module 222 and a screen manager module 226, provide additional communication channels between the central processor 220 and operating system 220 and system components, for example, the display driver 230.

It is noted that in one embodiment, central processor 220 executes logic (e.g., by way of programming, code, or instructions) corresponding to executing applications interfaced through, for example, the navigation area 140 or switches. It is noted that numerous other components and variations are possible to the hardware architecture of the computing device 200, thus an embodiment such as shown by FIG. 2 is just illustrative of one implementation for an embodiment.

In one embodiment, the window manager module 222 comprises a software (e.g., integrated with the operating system) or firmware (lower level code that resides is a specific memory for that code and for interfacing with specific hardware, e.g., the processor 220). The window manager module 222 is configured to initialize a virtual display space, which may be stored in the RAM 216 and/or the flash memory 214. The virtual display space includes one or more applications currently being executed by a user and the current status of the executed applications. The window manager module 222 receives requests, from user input or from software or firmware processes, to show a window and determines the initial position of the requested window. Additionally, the window manager module 222 receives commands or instructions to modify a window, such as resizing the window, moving the window or any other command altering the appearance or position of the window, and modifies the window accordingly.

The screen manager module 226 comprises a software (e.g., integrated with the operating system) or firmware. The screen manager module 226 is configured to manage content that will be displayed on the screen 130. In one embodiment, the screen manager module 226 monitors and controls the physical location of data displayed on the screen 130 and which data is displayed on the screen 130. The screen manager module 226 alters or updates the location of data as viewed on the screen 130. The alteration or update is responsive to input from the central processor 220 and display driver 230, which modifies appearances displayed on the screen 130. In one embodiment, the screen manager 226 also is configured to monitor and control screen brightness. In addition, the screen manager 226 is configured to transmit control signals to the central processor 220 to modify power usage of the screen 130.

A list manager module 228 comprises software and/or firmware configured to display lists in a graphical UI on the touch sensitive screen 130 and facilitate the user to navigate the lists by making on-screen gestures. According to one embodiment, the list manager module 228 sorts items in a list based on a common attribute of the items, groups the items into different categories (also called folders) associated with the attribute, and displays a portion of the list in the sorted sequence in the graphical UI. The user can navigate to different categories of the items in the list by making on-screen gestures. To facilitate the user to quickly navigate to the desired item (or category), the list manager module 228 dynamically and prominently displays indicators of the categories that correspond to the on-screen gesture as the gesture progresses.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120. The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (GPRS), third-generation (3G) mobile (or greater), High Speed Download Packet Access (HSDPA), High Speed Uplink Packet Access (HSUPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using the data line (or bus) 278.

The card interface 224 is adapted to communicate, wirelessly or wired, with external accessories (or peripherals), for example, media cards inserted into the expansion slot (not shown). The card interface 224 transmits data and/or instructions between the central processor and an accessory, e.g., an expansion card or media card, coupled within the expansion slot. The card interface 224 also transmits control signals from the central processor 220 to the expansion slot to configure the accessory. It is noted that the card interface 224 is described with respect to an expansion card or media card; it also may be structurally configured to couple with other types of external devices for the device 110, for example, an inductive charging station for the power supply 240 or a printing device.

### Example Architecture of List Manager Module

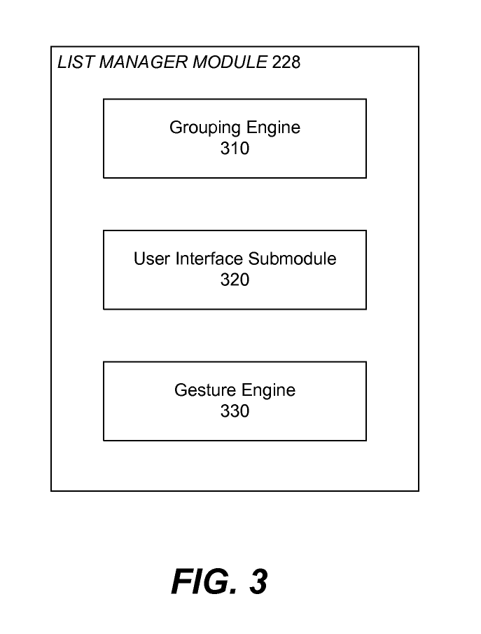

Referring now to FIG. 3, a block diagram illustrating submodules within the list manager module 228 according to one embodiment. Some embodiments of the module 228 have different and/or other submodules than the ones described herein. Similarly, the functions can be distributed among the submodules in accordance with other embodiments in a different manner than is described here. As illustrated, the list manager module 228 includes a grouping engine 310, a user interface submodule (also called the “UI submodule”) 320, and a gesture engine 330.

The grouping engine 310 is configured to group items in a list into several categories according to one or more common attributes of the items. In one embodiment, the grouping engine 310 sorts the items based on a common attribute, identifies several categories for the attribute, and groups the sorted items into the identified categories. The attribute used for sorting and grouping items may be predetermined for each type of items (e.g., last name for contacts, scheduled time for calendar entries), and can be modified (e.g., by the user) if needed. Similarly, the categories associated with each attribute can be predetermined and subsequently modified as needed. Each category is associated with a category indicator, a string or image (e.g., an icon) that uniquely identifies the associated category from other categories of the same attribute. For example, the category indicators of alphabetic categories A through Z are ‘A’, ‘B’, . . . , ‘Z’, accordingly.

For example, the grouping engine 310 sorts a list of contacts according to the alphabetical order of their last names, and groups the sorted contacts into categories A-Z according to the first characters of their last names (e.g., category A includes contacts with last names such as Adams and Arthur, and category S includes contacts with last names such as Smith and Sullivan). The user can modify the sorting criteria (e.g., in reverse alphabetical order) or sort the contacts using other attributes (e.g., first names, phone numbers). The user can also modify the categorization (e.g., three categories “A-H”, “I-P”, and “Q-Z” instead of twenty-six categories A-Z). As another example, the grouping engine 310 sorts a list of emails according to the chronological sequence of their receiving time, and groups the emails according to a set of predetermined categories (e.g., “today”, “yesterday”, “last week”, “previous month”, etc.).

In one embodiment, items in a list may come presorted (e.g., sorted by another application). In such cases, instead of re-sorting the items in the list, the grouping engine 310 utilizes the preexisting sequence by identifying the attribute(s) used to sort the list, identifying the corresponding categories, and grouping the items into the categories.

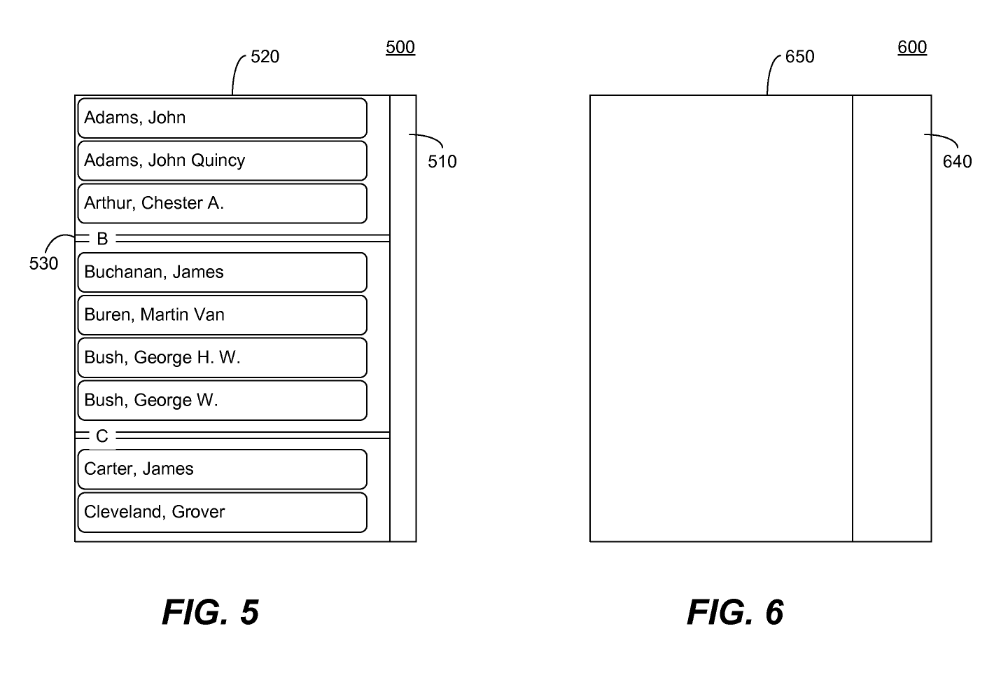

The UI submodule 320 is configured to generate a graphical UI to display items in a list. Referring to FIG. 5, illustrated is a screenshot of an example graphical UI 500 generated by the UI submodule 320 displaying a list of U.S. Presidents, according to one embodiment. As shown, the graphical UI 500 includes a category scroll bar 510 on the right, and a sliding window 520 on the left. The names of a few U.S. Presidents are shown in the sliding window 520. The names are sorted in alphabetical order of their last names, and grouped into categories A-Z based on the first character of their last names. As shown, the names are displayed in the sorted order and separated according to their categories. For example, names with last names starting with the character A and names with last names starting with the character B are separated with a separator (also called “divider”) 530 labeled with a category indicator ‘B’, indicating the following names are in the category B.

In one embodiment, the category scroll bar 510 indicates the positions of items that fall into different categories in the list. For example, the category scroll bar 510 includes category indicators, and/or icons (or symbols) that represent the categories. For example, the UI submodule 320 may display character symbols, for example, a diamond symbols (e.g., ⋄), on the category scroll bar 510 to represent the categories, with the length of a diamond reflecting the number of items in the corresponding category. As a result, a category with many items is represented by a long diamond, a category with few items is represented by a short diamond, and a category with no items is not represented at all or is only represented by a small dot. Alternately, a number of character symbols may be used to correspond to a quantity of items within a category. The category scroll bar 510 may also indicate the position of the items currently displayed on the sliding window 520 in the list. For example, the symbol(s) representing the category(ies) the currently displayed items fall into may be highlighted to visually distinguish from the other symbols on the category scroll bar 510.

The user can navigate within the list by making gestures on the graphical UI 500 as displayed on the touch sensitive screen 130. Examples of such on-screen gestures include single-touch gestures such as a tap, a press-and-hold, and a single-point drag, and multi-touch gestures such as a two-point drag. A tap is a gentle brief strike by a gesturing mechanism (e.g., by a finger or stylus) on the screen 130. A press-and-hold is a prolonged touch by a gesturing mechanism on the screen 130. A drag involves one or more gesturing mechanisms touching and sliding on the screen 130. A drag involving a single gesturing mechanism is called a single-point drag, and a drag involving two gesturing mechanisms is called a two-point drag.

Referring back to FIG. 3, the gesture engine 330 detects on-screen gestures made on the touch sensitive screen 130 and collects related information. Examples of the related information include the locations of the gestures with respect to the graphical UI (e.g., the starting location and the ending location of a single-point drag), the directions of the gestures with respect to the graphical UI (e.g., upward towards the beginning of the list or downward towards the end of the list), and the duration of the gestures (e.g., starting from when the gesturing mechanism touches the screen 130 to when the mechanism is lifted from the screen 130).

The gesture engine 330 interprets the detected on-screen gestures into corresponding navigation commands, and works with the UI submodule 320 to execute the navigation commands. On-screen gestures are interpreted based on their related information such as location, direction, and duration. In one embodiment the location and direction information may be coordinate parameters that can be calculated into a directional vector. The calculated directional vector can correspond to a particular command (or instruction), for example, as predefined and stored in a table within the flash memory 214. The duration can also be a parameter, for example, a predetermined number of milliseconds or seconds, that can correspond to an addition command (or instruction), for example, as also predefined within the table stored within the flash memory 214. By way of example, in one embodiment, depending on the location a gesture is detected on the graphical UI, the gesture may be interpreted into different navigation commands. The navigation commends may be stored in the table in the flash memory 214 along with a corresponding gesture (e.g., directional vector). For example, a gesture (e.g., applied on the screen 130 with a finger or stylus) from right to left along an x-axis may correspond to “back” and a gesture top to bottom along a y-axis may correspond to “scroll.”

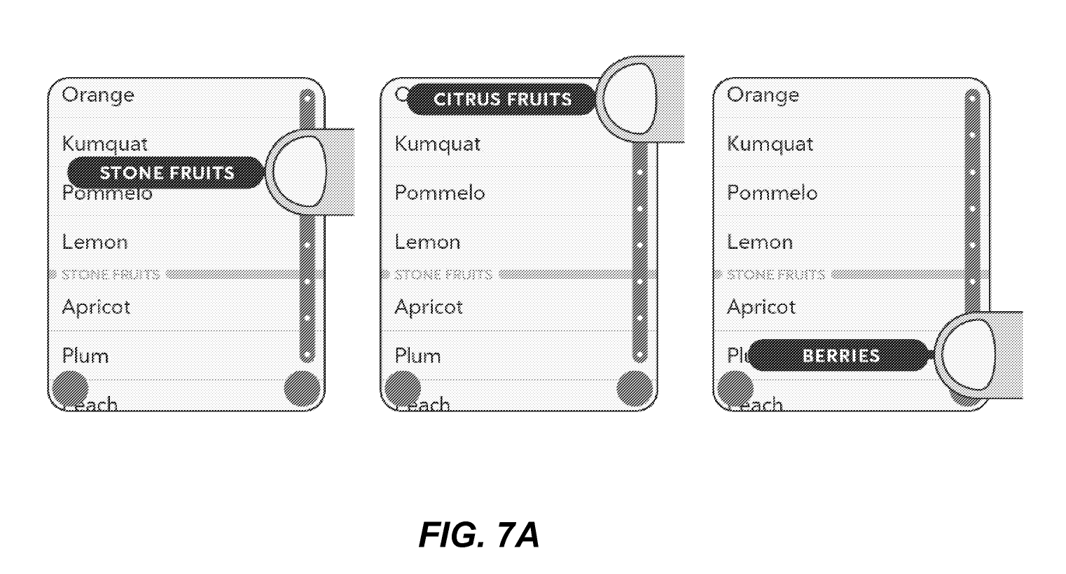

As further example, reference is made to FIG. 6, which illustrates a graphical UI 600 according to one embodiment. As shown, the graphical UI 600 is divided into two regions, a category-based gesture input region 640, and a standard gesture input region 650. Depending on whether an on-screen gesture is detected in the category-based gesture input region 640 or in the standard gesture input region 650, the gesture engine 330 may interpret the gesture differently. The regions 640, 650 are defined for the gesture engine 330 to interpret on-screen gestures, and are not necessarily visually distinguishable. As illustrated in FIGS. 5 and 6, the category-based gesture input region 640 and the category scroll bar 510 are both on the right of the graphical UI. In one embodiment, the category-based gesture input region 640 is wider than the category scroll bar 510.

The following are additional example gesture interpretations according to one embodiment. If a tap gesture is detected on the standard gesture input region 650, the gesture engine 330 interprets the gesture as an item-selection command, and works with the UI submodule 320 to select the item that is displayed closest to the gesture location and highlight the item on the graphical UI to provide a visual confirmation of the selection. If the tap is detected on the category-based gesture input region 640, the gesture engine 330 interprets the gesture as a category look-up command. As a result, the gesture engine 330 identifies an item position in the displayed list that corresponds to the vertical location of the gesture as projected onto the category scroll bar 510, determines a category of the item in the identified position, and works with the UI submodule 320 to display the category indicator of the category prominently at a location near the gesture location for a short period of time.

If a press-and-hold gesture is detected on the standard gesture input region 650, the gesture engine 330 interprets the gesture as an item-activation command, and works with the UI submodule 320 to activate the item that is displayed closest to the gesture location (e.g., to display additional information or to enable the user to edit the item). If the press-and-hold gesture is detected on the category-based gesture input region 640, the gesture engine 330 interprets the gesture as a navigate-to-category command. Similar to the category look-up command, the gesture engine 330 identifies a position in the displayed list that corresponds to the vertical location of the gesture as projected onto the category scroll bar 510 and determines a category of the item in the identified position. Unlike the category look-up command, the gesture engine 330 displays the category indicator as long as the gesture lasts. In addition, once the press-and-hold gesture ends (e.g., the gesturing mechanism is lifted from the touch sensitive screen 130), the UI submodule 320 scrolls the sliding window 520 to display the identified portion of the list. In one embodiment, to prevent accidental touches, the UI submodule 320 only scrolls if the duration of the gesture exceeds a threshold duration value (e.g., 1 second).

If a single-point drag gesture is detected on the standard gesture input region 650, the gesture engine 330 interprets the gesture as a standard scrolling command, and works with the UI submodule 320 to scroll the sliding window 520 in the direction of the gesture. The speed and extent of the scroll operation may be determined based on the speed and the length of the drag gesture. If a single-point drag gesture is detected on the category-based gesture input region 640, the gesture engine 330 interprets the gesture as a category-based scrolling command, and dynamically and prominently displays the identifiers of the categories corresponding to the gesture in real time as the gesture progresses. In one embodiment, as the gesturing mechanism (or gesture action) slides along the category-based gesture input region 640, the gesture engine 330 identifies a position in the list that corresponds to the current vertical location of the mechanism as projected onto the category scroll bar 510, determines a category of the item in the identified position, and dynamically and prominently displays the category indicator in real time. Once the drag gesture ends (e.g., when the action stops, e.g., by lifting a finger or stylus off the touch sensitive screen 130), the gesture engine 330 works with the UI submodule 320 to scroll the sliding window 520 to display items in the most recent category identified by the drag gesture. In one embodiment, if a two-point drag gesture is detected anywhere on the graphical UI, the drag is interpreted as a category-based scrolling command.

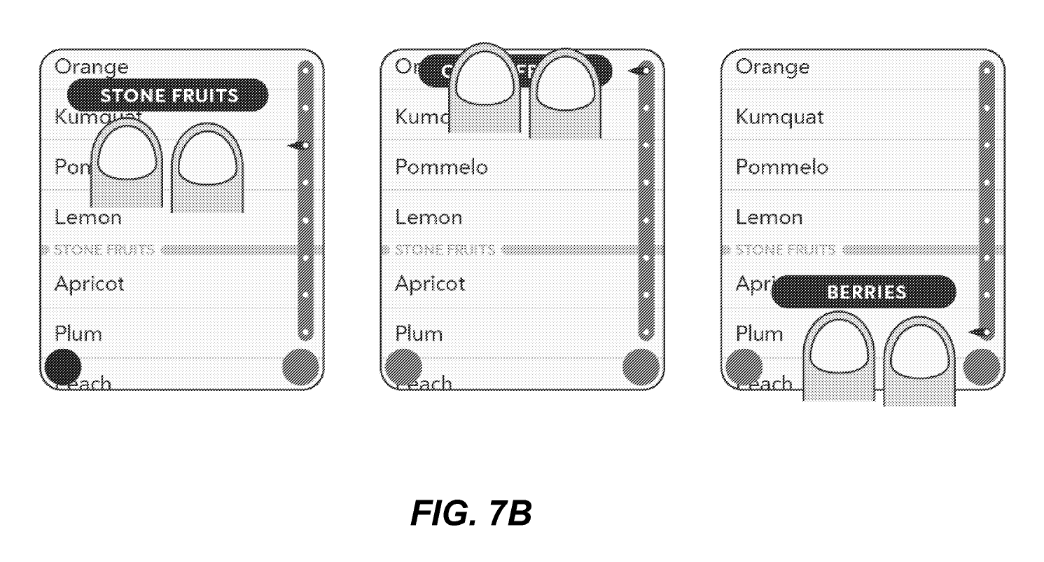

FIG. 7A are screenshots of an example graphical UI generated by the UI submodule 320 in response to a single-point drag gesture on the category-based gesture input region 640, according to one embodiment. In this example, the gesture operation will be described through actions of a user finger interacting with the screen 130. The graphical UI displays a list of fruits grouped into different fruit types. As shown in the left screenshot, when a finger touches the category scroll bar 510, the gesture engine 330 determines that the fruit located at the corresponding position in the displayed list is in the stone fruit category, and works with the UI submodule 320 to display the corresponding category indicator “STONE FRUITS” near the gestured area. As shown in the center screenshot, as the finger drags towards the top of the category scroll bar 510, the gesture engine 330 determines that the corresponding fruit is in the citrus fruit category, and the UI submodule 320 displays “CITRUS FRUITS” as a result. As shown in the right screenshot, as the finger drags downwards to the bottom of the category scroll bar 510, the gesture engine 330 determines that the corresponding fruit is in the berry category, and accordingly the UI submodule 320 displays “BERRIES”. FIG. 7B are screenshots illustrating that the user can issue a similar category-based scrolling command by making a two-finger drag gesture on the standard gesture input region 650.

### Example Process of List Manager Module

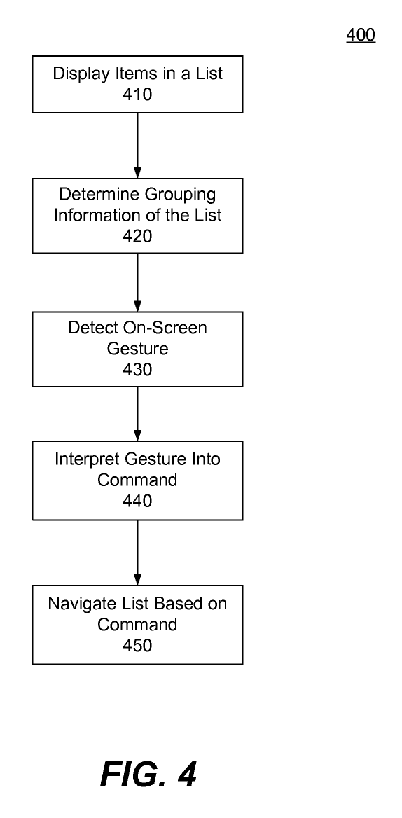

Referring now to FIG. 4, a flowchart of a process 400 illustrating a process for the list manager module 228 to enable a user to navigate within a list on a mobile computing device by making on-screen gestures according to one embodiment. Other embodiments can perform the steps of the process 400 in different orders. Moreover, other embodiments can include different and/or additional steps than the ones described herein.

As shown, the list manager module 228 displays 410 items in a list in a graphical UI on a touch sensitive screen 130 of a mobile computing device 110. In one embodiment, the list manager module 228 sorts items in the list according to a common attribute, and displays 410 the list (or more typically, a portion of the list) in the sorted sequence.

The list manager module 228 determines 420 the grouping information of the list. The grouping information includes the categories associated with the attribute used to sort the list, and the number of items belonging to each of the categories. The list manager module 228 indicates the grouping information in a category scroll bar in the graphical UI.

The list manager module 228 detects 430 on-screen gestures a user makes on the touch sensitive screen 130, and collects related information such as the gesture locations, the gesture directions, and the durations of the gestures. The list manager module 228 interprets 440 the detected gestures into navigation commands based on the related information, and navigates 450 the list based on the commands.

The described configuration provides a mechanism for a user to navigate a displayed list by making on-screen gestures. Because the user can locate the category of a desired item on the list by gesturing on a category-based gesture input region, the user can navigate to the desired item quickly by browsing through the items within that category.

Some portions of above description describe the embodiments in terms of algorithms and symbolic representations of operations on information, for example, as illustrated and described with respect to FIG. 4. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for enabling a user to navigate within a list on a touch sensitive screen by making on-screen gestures through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for navigating a list of items on a touch sensitive screen of a mobile computing device, the method comprising:
grouping items in the list into a plurality of categories based on an attribute associated with two or more of the items in the list;
providing for display a subset of the items in the list in a graphical user interface (UI) on the touch sensitive screen based on categories of the subset of the items;
receiving, via the touch sensitive screen, an on-screen gesture;
identifying one of the plurality of categories associated with the on-screen gesture;
providing for display an indicator of the identified category on the graphical UI; and
scrolling the graphical UI to a portion of the list associated with the identified category.

2. The method of claim 1, wherein the user confirmation comprises a determination that a duration of the on-screen gesture exceeds a threshold time.

3. The method of claim 1, further comprising:
sorting the items in the list into a sequence based on the attribute, wherein grouping the items in the list comprises grouping the items in the sequence into the plurality of categories based on the attribute.

4. The method of claim 1, further comprising:
providing for display a category scroll bar in the graphical UI for indicating the plurality of categories, the items grouped into the plurality of categories.

5. The method of claim 4, wherein identifying one of the plurality of categories associated with the on-screen gesture comprises:
identifying a position in the list corresponding to a vertical location of the on-screen gesture related to the category scroll bar; and
identifying the one of the plurality of categories based on the item located at the identified position.

6. A mobile computing device, comprising:
a touch-sensitive screen; and
a non-transitory computer-readable storage medium storing executable computer program code for navigating a list of items on the touch sensitive screen, the computer program code comprising program code for:
grouping items in the list into a plurality of categories based on an attribute associated with two or more of the items in the list;
providing for display a subset of the items in the list in a graphical user interface (UI) on the touch sensitive screen based on categories of the subset of the items;
receiving, via the touch sensitive screen, an on-screen gesture;
identifying one of the plurality of categories associated with the on-screen gesture;
providing for display an indicator of the identified category on the graphical UI; and
scrolling the graphical UI to a portion of the list associated with the identified category.

7. The mobile computing device of claim 6, wherein the user confirmation comprises a determination that a duration of the on-screen gesture exceeds a threshold time.

8. The mobile computing device of claim 6, wherein the computer program code further comprises program code for:
sorting the items in the list into a sequence based on the attribute, wherein grouping the items in the list comprises grouping the items in the sequence into the plurality of categories based on the attribute.

9. The mobile computing device of claim 6, wherein the computer program code further comprises program code for:
providing for display a category scroll bar in the graphical UI for indicating the plurality of categories, the items grouped into the plurality of categories.

10. The mobile computing device of claim 9, wherein identifying one of the plurality of categories associated with the on-screen gesture comprises:
identifying a position in the list corresponding to a vertical location of the on-screen gesture related to the category scroll bar; and
identifying the one of the plurality of categories based on the item located at the identified position.

11. A non-transitory computer-readable storage medium encoded with executable computer program code for navigating a list of items on a touch sensitive screen of a mobile computing device, the computer program code comprising program code for:
grouping items in the list into a plurality of categories based on an attribute associated with two or more of the items in the list;
providing for display a subset of the items in the list in a graphical user interface (UI) on the touch sensitive screen based on categories of the subset of the items;
receiving, via the touch sensitive screen, an on-screen gesture;
identifying one of the plurality of categories associated with the on-screen gesture;
providing for display an indicator of the identified category on the graphical UI; and
scrolling the graphical UI to a portion of the list associated with the identified category.

12. The non-transitory computer-readable storage medium of claim 11, wherein the user confirmation comprises a determination that a duration of the on-screen gesture exceeds a threshold time.

13. The non-transitory computer-readable storage medium of claim 11, wherein the computer program code further comprises program code for:
sorting the items in the list into a sequence based on the attribute, wherein grouping the items in the list comprises grouping the items in the sequence into the plurality of categories based on the attribute.

14. The non-transitory computer-readable storage medium of claim 11, wherein the computer program code further comprises program code for:
providing for display a category scroll bar in the graphical UI for indicating the plurality of categories, the items grouped into the plurality of categories.

15. The non-transitory computer-readable storage medium of claim 14, wherein identifying one of the plurality of categories associated with the on-screen gesture comprises:
identifying a position in the list corresponding to a vertical location of the on-screen gesture related to the category scroll bar; and
identifying the one of the plurality of categories based on the item located at the identified position.
